(19) United States
(12) Patent Application Publication
(10) Pub. No.: US 2020/0225734 A1
(43) Pub. Date: Jul. 16, 2020

(54) DISPLAY APPARATUS AND METHOD OF INDICATING LEVEL OF IMMERSION USING VISUAL INDICATOR

(71) Applicant: Varjo Technologies Oy, Helsinki (FI)

(72) Inventors: Birgir Magnusson, Paippinen (FI); Jussi Mäkinen, Helsinki (FI); Roope Rainisto, Helsinki (FI); Aaron Toney, Seattle, WA (US); Urho Konttori, Helsinki (FI)

(21) Appl. No.: 16/245,309

(22) Filed: Jan. 11, 2019

(51) Int. Cl. G06F 3/01; G02B 27/01; G06F 3/03; G06T 19/00

(52) U.S. Cl. CPC G06F 3/011; G06T 19/006; G06F 3/0304; G02B 27/0172

(57) ABSTRACT

Disclosed is a display apparatus and a method of indicating a level of immersion of the user. The display apparatus comprises: at least one image renderer for rendering an image; a see-through arrangement for projecting a real world image upon user's eyes; at least one optical combiner for optically combining a projection of the rendered image with a projection of the real world image to create a visual scene; means for detecting a gaze-direction of the user; a visual indicator for indicating a level of immersion of the user when the display apparatus is in use, and positioned on an outer side of the display apparatus; and a processor configured to generate a drive signal for the visual indicator, based upon at least one of: the gaze direction of the user, a current mode of operation of the display apparatus, and to control the visual indicator via the drive signal.

### TECHNICAL FIELD

The present disclosure relates generally to simulated environments; and more specifically, to display apparatuses comprising image renderers, see-through arrangements, optical combiners, means for detecting a gaze-direction, visual indicators and processors. Furthermore, the present disclosure also relates to methods of indicating a level of immersion, via the aforementioned display apparatuses.

### BACKGROUND

In recent times, there has been rapid advancement in development and use of technologies such as virtual reality, augmented reality, augmented virtuality, and so forth, for presenting a simulated environment to a user. Furthermore, such simulated environments enhance the user's perception of reality around him/her. Moreover, such simulated environments could relate to fully virtual environments (namely, virtual reality environments), real world environments including virtual objects overlaid thereon (namely, augmented reality environments), and virtual environments including real-world objects overlaid thereon (namely, augmented virtuality environments).

Typically, for experiencing such a simulated environment, the user may use a device, for example, such as a virtual reality device, a mixed reality device, and the like. Generally, such devices are binocular devices having dedicated display optics for each eye of the user. Examples of the virtual reality devices include head mounted virtual reality devices, virtual reality glasses, and so forth. Furthermore, examples of the mixed reality devices include mixed reality headsets, mixed reality glasses, and so forth. Specifically, such devices provide the user with a feeling of complete immersion in the simulated environment.

However, there exists a lack of provisions for indicating the user's level of immersion within such simulated environments to people within actual surroundings of the user. Consequently, such people often end up disturbing the user, thereby, severely diminishing the user's experience of the simulated environment. Moreover, there are no provisions to inform such people about activities that the user may be engaged in, within the simulated environment, and other information, for example, such as the user's availability for interaction. Additionally, if the user is highly immersed in the simulated environment, he/she may have severely limited perception of occurrences in the actual surroundings of the user (for example, such as a person waving at the user to grab his/her attention, ringing of the user's mobile phone, and so forth). Therefore, the user is unable to appropriately react to such occurrences around him/her.

Therefore, in light of the foregoing discussion, there exists a need to overcome the aforementioned drawbacks associated with indicating a user's immersion within simulated environments.

### SUMMARY

The present disclosure seeks to provide a display apparatus. The present disclosure also seeks to provide a method of indicating a level of immersion of a user of a display apparatus. The present disclosure seeks to provide a solution to the existing problem of difficulty in indicating the level of immersion of the user within simulated environments, to people within actual surroundings of the user. An aim of the present disclosure is to provide a solution that overcomes at least partially the problems encountered in prior art, and provides a reliable, user-friendly and efficient display apparatus that effectively indicates the level of immersion of the user, to viewers present in the user's physical, real world surroundings.

In one aspect, an embodiment of the present disclosure provides a display apparatus comprising:
at least one image renderer for rendering an image;
a see-through arrangement for projecting a real world image upon a user's eyes, when the display apparatus is head-mounted by the user;
at least one optical combiner for optically combining a projection of the rendered image with a projection of the real world image to create a visual scene;
means for detecting a gaze-direction of the user;
a visual indicator for indicating a level of immersion of the user when the display apparatus is in use, the visual indicator being positioned on an outer side of the display apparatus, so as to be visible to a viewer present in the user's surroundings; and
a processor coupled to the at least one image renderer, the see-through arrangement, the at least one optical combiner, the means for detecting the gaze direction, and the visual indicator, wherein the processor is configured to generate a drive signal for the visual indicator, based upon at least one of: the gaze direction of the user, a current mode of operation of the display apparatus, and to control the visual indicator via the drive signal.

In another aspect, an embodiment of the present disclosure provides a method of indicating a level of immersion of a user of a display apparatus, the display apparatus comprising at least one image renderer, a see-through arrangement, at least one optical combiner, means for detecting a gaze-direction of the user, and a visual indicator, the visual indicator being positioned on an outer side of the display apparatus, so as to be visible to a viewer present in the user's surroundings, the method comprising:
rendering an image via the at least one image renderer;
projecting a real world image upon the user's eyes, via the see-through arrangement, when the display apparatus is head-mounted by the user;
optically combining, via the at least one optical combiner, a projection of the rendered image with a projection of the real world image to create a visual scene;
detecting the gaze-direction of the user, via the means for detecting the gaze direction;
generating a drive signal for the visual indicator, based upon at least one of: the gaze direction of the user, a current mode of operation of the display apparatus; and
controlling the visual indicator, via the drive signal, to indicate the level of immersion of the user when the display apparatus is in use.

Embodiments of the present disclosure substantially eliminate or at least partially address the aforementioned problems in the prior art, and provides indication of the level of immersion of the user to the viewer, whilst the user uses the display apparatus.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of architecture of a display apparatus, in accordance with an embodiment of the present disclosure;

FIGS. 2 and 3 illustrate perspective views of the display apparatus, in accordance with different embodiments of the present disclosure;

FIG. 4 illustrates steps of a method for indicating a level of immersion of a user of a display apparatus, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a display apparatus comprising:
at least one image renderer for rendering an image;
a see-through arrangement for projecting a real world image upon a user's eyes, when the display apparatus is head-mounted by the user;
at least one optical combiner for optically combining a projection of the rendered image with a projection of the real world image to create a visual scene;
means for detecting a gaze-direction of the user;
a visual indicator for indicating a level of immersion of the user when the display apparatus is in use, the visual indicator being positioned on an outer side of the display apparatus, so as to be visible to a viewer present in the user's surroundings; and
a processor coupled to the at least one image renderer, the see-through arrangement, the at least one optical combiner, the means for detecting the gaze direction, and the visual indicator, wherein the processor is configured to generate a drive signal for the visual indicator, based upon at least one of: the gaze direction of the user, a current mode of operation of the display apparatus, and to control the visual indicator via the drive signal.

In another aspect, an embodiment of the present disclosure provides a method of indicating a level of immersion of a user of a display apparatus, the display apparatus comprising at least one image renderer, a see-through arrangement, at least one optical combiner, means for detecting a gaze-direction of the user, and a visual indicator, the visual indicator being positioned on an outer side of the display apparatus, so as to be visible to a viewer present in the user's surroundings, the method comprising:
rendering an image via the at least one image renderer;
projecting a real world image upon the user's eyes, via the see-through arrangement, when the display apparatus is head-mounted by the user;
optically combining, via the at least one optical combiner, a projection of the rendered image with a projection of the real world image to create a visual scene;
detecting the gaze-direction of the user, via the means for detecting the gaze direction;
generating a drive signal for the visual indicator, based upon at least one of: the gaze direction of the user, a current mode of operation of the display apparatus; and
controlling the visual indicator, via the drive signal, to indicate the level of immersion of the user when the display apparatus is in use.

The present disclosure provides the aforementioned display apparatus and the aforementioned method of displaying, via such a display apparatus. The display apparatus described herein allows for providing indication (for example, such as a visual indication) to people within actual surroundings of the user of the display apparatus, about the user's level of immersion in a simulated environment. Moreover, the display apparatus described herein allows for such people to become aware about an activity that the user may be engaged in, within the simulated environment. Additionally, the described display apparatus could provide information to such people about the user's availability for interaction. Furthermore, the display apparatus facilitates an unperturbed immersive experience of the simulated environment for the user of the display apparatus. Moreover, the display apparatus could also allow for the user to have perception of occurrences in his/her actual surroundings. Consequently, the user may appropriately react to such occurrences around him/her.

Throughout the present disclosure, the term “display apparatus” used herein relates to specialized equipment that is configured to display (namely, present) the visual scene (for example, such as a visual scene of a simulated environment) to the user of the display apparatus. In such an instance, the display apparatus is operable to act as a device (for example, such as a virtual reality headset, a mixed reality headset, a pair of virtual reality glasses, a pair of mixed reality glasses, augmented reality glasses and so forth) for displaying the visual scene to the user.

As mentioned previously, the at least one image renderer is configured to render the image. In such an instance, the rendered image is projected onto the user's eye when the display apparatus is head-mounted by the user. According to an embodiment, the term “image” used herein relates to a representation of a virtual scene of the simulated environment (for example, such as a virtual reality environment) to be displayed via the display apparatus. According to another embodiment, the term “image” used herein relates to a representation of at least one virtual object. Examples of the at least one virtual object include, but are not limited to, a virtual navigation tool, a virtual gadget, a virtual message, a virtual entity, and a virtual media.

Throughout the present disclosure, the term “at least one image renderer” used herein relates to equipment configured to facilitate rendering of the image. Optionally, the at least one image renderer comprises at least a context image renderer for rendering a context image and a focus image renderer for rendering a focus image, wherein a projection of the rendered context image and a projection of the rendered focus image together form the projection of the rendered image. In such an instance, the image comprises the context image and the focus image. Therefore, the context image and the focus images are rendered substantially simultaneously in order to collectively constitute the rendered image at the at least one image renderer.

Optionally, the context image relates to an image of the virtual scene, or the at least one virtual object, to be rendered and projected via the at least one context image renderer. Furthermore, optionally, the focus image relates to another image depicting a part (namely, a portion) of the virtual scene, or the at least one virtual object, to be rendered and projected via the at least one focus image renderer. Moreover, the focus image is dimensionally smaller than the context image.

Throughout the present disclosure, the term “context image renderer” used herein relates to equipment configured to facilitate rendering of the context image. Similarly, the term “focus image renderer” used herein relates to equipment configured to facilitate rendering of the focus image.

In an embodiment, the context image renderer and/or the focus image renderer are implemented by way of at least one projector and a projection screen associated therewith. Optionally, a single projection screen may be shared between the at least one projector employed to implement the context image renderer and the focus image renderer. Optionally, in this regard, the context image renderer and/or the focus image renderer are selected from the group consisting of: a Liquid Crystal Display (LCD)-based projector, a Light Emitting Diode (LED)-based projector, an Organic LED (OLED)-based projector, a Liquid Crystal on Silicon (LCoS)-based projector, a Digital Light Processing® (DLP)-based projector, and a laser projector.

In another embodiment, the context image renderer is implemented by way of at least one context display configured to emit the projection of the rendered context image therefrom, and the focus image renderer is implemented by way of at least one focus display configured to emit the projection of the rendered focus image therefrom. Optionally, in this regard, the context image renderer and the focus image renderer are selected from the group consisting of: a Liquid Crystal Display (LCD), a Light Emitting Diode (LED)-based display, an Organic LED (OLED)-based display, a micro OLED-based display, a Liquid Crystal on Silicon (LCoS)-based display, and a Digital Light Processing® (DLP)-based display.

As mentioned previously, the display apparatus comprises the see-through arrangement for projecting the real world image upon the user's eyes, when the display apparatus is head-mounted by the user. Throughout the present disclosure, the term “real world image” used herein relates to an image depicting actual surroundings of the user whereat he/she is positioned. Furthermore, throughout the present disclosure, the term “see-through arrangement” used herein relates to equipment (for example, such as optical elements, electronic components, and so forth) configured to project the user's surroundings onto the user's eyes, through the display apparatus, when the display apparatus is head mounted by the user. In an example, when the display apparatus is head mounted by the user, he/she may not be able to view his/her surroundings since the display apparatus may block a field of view of the user's eyes. In such an example, the see-through arrangement may beneficially allow the user to view his/her surroundings.

In an embodiment, the see-through arrangement is a video see-through arrangement. Throughout the present disclosure, the term “video see-through arrangement” used herein relates to equipment that is configured to capture the real world image of the user's surroundings and to project the real world image onto the user's eyes, through the display apparatus (for example, such as virtual reality headset or the mixed reality headset). It will be appreciated that a sequence of the real world images projected through the video see-through arrangement constitutes a video of the real world. Furthermore, optionally, the video see-through arrangement comprises at least one imaging device (for example, such as a digital camera) to capture the real world image of the user's surroundings. In such a case, the at least one imaging device is provided on an outer side of the display apparatus. It will be appreciated that the at least one imaging device is a specialized equipment that captures the real world image of the user's surroundings. Notably, the at least one imaging device is configured to capture the real world image from the user's perspective. Furthermore, it will be appreciated that the at least one imaging device could be a two-dimensional camera or a three-dimensional depth camera (namely, a ranging camera). Examples of the at least one imaging device include, but are not limited to, a digital camera, an RGB-D camera, a Light Detection and Ranging (LiDAR) camera, a Time-of-Flight (ToF) camera, a Sound Navigation and Ranging (SONAR) camera, a laser rangefinder, a stereo camera, a plenoptic camera, an infrared camera, and an ultrasound imaging equipment.

In another embodiment, the see-through arrangement is an optical see-through arrangement. Throughout the present disclosure, the term “optical see-through arrangement” used herein relates to equipment arranged in a manner to directly project, by way of passing therethrough, the real world image onto the user's eyes. In such an instance, the display apparatus is equipped with at least one optical element used to implement the optical see-through arrangement, through which the user is able to view the real world image of his/her surroundings. In an example, the optical see-through arrangement is implemented by way of a semi-transparent mirror.

As mentioned previously, the at least one optical combiner is configured to optically combine the projection of the rendered image with the projection of the real world image to create the visual scene. Throughout the present disclosure, the term “at least one optical combiner” used herein generally refers to equipment (for example, such as optical elements, displays, and so forth) for combining the projection of the rendered image with the projection of the real world image to constitute a resultant projection of the visual scene of the simulated environment. Notably, the projection of the real world image projected through the see-through arrangement, and the projection of the rendered image are directed towards the at least one optical combiner, whereat the aforesaid projections are optically combined. Optionally, upon such optical combination, the resultant projection of the visual scene includes the at least one virtual object overlaid on actual surroundings of the user. Beneficially, the resultant projection of the visual scene is projected onto the user's eyes. Therefore, the at least one optical combiner is also arranged for directing the resultant projection substantially towards a direction of the user's eyes.

Optionally, the processor is configured to control the see-through arrangement and/or the at least one optical combiner to provide different transparency levels for the real world image when creating the visual scene, and to employ the visual indicator to indicate to the viewer whether or not the user is able to see the viewer in the real world image. Optionally, in this regard, the at least one optical combiner is switchable to different levels of transparency to provide the user with different types of simulated environments. Optionally, the levels of transparency of the at least one optical combiner is controlled electrically by the processor to combine the projection of the rendered image with the projection of the real world image, as desired by the user.

It will be appreciated that the visual indicator to indicate to the viewer whether or not the user is able to see the viewer in the real world image, by way of at least one of: colour-based indication, image indication, textual indication. As an example, a colour of the visual indicator when the user is able to see the viewer in the real world image may be different from a colour of the visual indicator when the user is unable to see the viewer in the real world image.

In an example, the at least one optical combiner may be semi-transparent (for example, 30 percent, 40 percent, 50 percent, 60 percent, 70 percent or 80 percent transparent) to combine the projection of the rendered image with the projection of the real world image for providing the user with a visual scene of an augmented reality simulated environment. In such an instance, the user views his/her surroundings having the at least one virtual object (depicted by the rendered image) overlaid thereon, and the user may be able to see the viewer in the real world image. Therefore, in such an instance, the visual indicator indicates to the viewer (for example, as a textual indication) that he/she is visible to the user, and the display apparatus operates in an ‘augmented reality mode’.

In another example, the at least one optical combiner may be highly transparent (for example, 90 percent, 95 percent, or 100 percent transparent) such that only the projection of the real world image is projected, by the see-through arrangement, onto the user's eyes, and the user may be able to see the viewer in the real world image. Furthermore, in such a case, the projection of the rendered image is suppressed from being projected onto the user's eyes. Therefore, in such an instance, the visual indicator indicates to the viewer that he/she is visible to the user, and the display apparatus operates in a ‘true reality mode’.

In yet another example, the at least one optical combiner may be highly opaque (for example, 0 percent, 10 percent or 20 percent transparent) such that only the projection of the rendered image is projected onto the user's eyes. In such a case, the projection of the real world image may be suppressed from being projected onto the user's eyes, and the user would be unable to see the viewer. Therefore, in such an instance, the visual indicator indicates to the viewer that he/she is invisible to the user, and the display apparatus operates in a ‘virtual reality mode’.

Optionally, the at least one optical combiner is implemented by way of at least one of: a semi-transparent mirror, a prism, a polarizer, an optical waveguide. For example, the at least one optical combiner may be implemented as an optical waveguide. In such a case, the optical waveguide may be arranged to allow the projection of the rendered image to pass towards the user's eyes by reflection therefrom. Moreover, in such a case, the optical waveguide may be transparent such that the projection of the real world image is visible therethrough. Optionally, for this purpose, the optical waveguide is semi-transparent. Alternatively, optionally, the optical waveguide is arranged to allow the projection of the real world image to pass towards the user's eyes by reflection therefrom, and the optical waveguide is transparent such that the projection of the rendered image is visible therethrough.

According to an embodiment, the at least one optical combiner is curved in shape. It will be appreciated that the curved shape of the at least one optical combiner can be in any suitable direction and shape, for example such as an outside-in hemisphere, an inside-out hemisphere, a parabolic shape, and so forth. Beneficially, the curved shape of the at least one optical combiner potentially increases a field of view of the display apparatus and facilitates a reduction in the size of the display apparatus. Furthermore, the curved shape of the at least one optical combiner enables a reduction in geometric and chromatic aberrations occurring within the display apparatus.

According to another embodiment, the at least one optical combiner is flat (namely, planar) in shape. According to yet another embodiment, the at least one optical combiner is freeform in shape. Optionally, in this regard, the freeform shape is implemented as a combination of flat and curved surfaces including protrusions and depressions on a surface of the at least one optical combiner. It will be appreciated that such a freeform-shaped optical combiner has dual benefit over a flat (namely, planar) optical combiner. Firstly, a wider field of view is potentially achieved by employing a dimensionally smaller freeform-shaped optical combiner, as compared to a flat optical combiner. Secondly, the freeform-shaped optical combiner potentially serves as a lens subsystem for controlling an optical path of the projection of the rendered image.

Optionally, the at least one optical combiner is also configured to optically combine the projection of the rendered context image with the projection of the rendered focus image to create the projection of the rendered image.

As mentioned previously, the display apparatus comprises the means for detecting the gaze-direction of the user. Throughout the present disclosure, the term “means for detecting a gaze direction” used herein relates to specialized equipment for detecting and/or following a direction of gaze of the user of the display apparatus, when the user of the display apparatus views the visual scene. Optionally, the means for detecting the gaze direction is placed in contact with the user's eyes. Alternatively, optionally, the means for detecting the gaze direction is placed in a contact-less manner with respect to the user's eyes. Examples of the means for detecting the gaze direction include contact lenses with sensors, cameras monitoring position of pupils of the user's eyes, and so forth. Beneficially, an accurate detection of the gaze direction facilitates the display apparatus to closely implement gaze contingency thereon.

Optionally, the processor is configured to determine a region of interest based upon the detected gaze direction of the user. More optionally, the processor is configured to control the operation of the means for detecting gaze direction so as to accurately detect the gaze direction of the user. It will be appreciated that the term “region of interest” used herein refers to a region of the visual scene whereat the detected gaze direction of the eye may be focused when the user views the visual scene. It will be appreciated that the region of interest is a fixation region within the visual scene. Therefore, the region of interest is a region of focus of the user's gaze within the visual scene. Furthermore, it is to be understood that the region of interest is resolved to a much greater detail as compared to other regions of visual scene, when the visual scene is viewed by a human visual system (namely, by the user's eyes).

Furthermore, optionally, the region of interest of the visual scene is represented within both the rendered context image of low resolution and the rendered focus image of high resolution. Moreover, the rendered focus image having a high resolution may include more information pertaining to the region of interest of the visual scene, as compared to the rendered context image having a low resolution. Therefore, it will be appreciated that the processor optionally masks the region of the context image that substantially corresponds to the region of interest of the visual scene in order to avoid optical distortion of the region of interest, when the projection of the focus image is combined with the projection of the rendered context image to create the projection of the rendered image.

In an example, the image rendered by the image renderer may depict two virtual objects namely, O1 and O2. Furthermore, the see-through arrangement may project the real world image, depicting an inside environment of a room, upon the user's eyes, when the display apparatus is head-mounted by the user. The real world image and the image rendered by the image renderer are combined using the at least one optical combiner to create a visual scene (for example, such as an augmented reality visual scene) depicting that the virtual objects O1 and O2 are superimposed on the inside environment of the room. In such an example, the virtual object O2 may be located at a right side region of the room and the virtual object O1 may be located at left region of the room. Moreover, the means for detecting the gaze-direction may detect a direction of gaze of the user's eyes and may transmit the detected gaze direction to the processor. In such a case, if the detected gaze direction of the user is towards the virtual object O1, the processor determines the virtual object O1 as the region of interest. Furthermore, in such an example, the user may change his/her gaze direction and may focus his/her gaze at a central region of the visual scene, depicting a chair in the room. In such a case, the processor may receive the detected gaze direction of the user and may determine the chair as the region of interest.

As mentioned previously, the visual indicator indicates the level of immersion of the user when the display apparatus is in use. The visual indicator is positioned on the outer side of the display apparatus, so as to be visible to the viewer present in the user's surroundings. Throughout the present disclosure, the term “level of immersion” used herein relates to an extent of involvement of the user in the visual scene when the display apparatus is being used by him/her, for viewing the visual scene.

Throughout the present disclosure, the term “visual indicator” used herein relates to equipment configured to provide a visual signal to the viewer present in the user's surroundings, wherein the visual signal relates to the extent of the user's involvement in the visual scene. It will be appreciated that the user may be involved in the visual scene in a manner that (i) he/she may be substantially unable to perceive real-world occurrences around him/her, thereby indicating a high level of immersion in the visual scene, (ii) he/she may have a limited perception of the real-world occurrences around him/her, thereby indicating a moderate level of immersion in the visual scene, (iii) he/she may fully perceive the real-world occurrences around him/her, thereby indicating a low level of immersion in the visual scene.

As mentioned previously, the processor is configured to generate the drive signal for the visual indicator, based upon at least one of: the gaze direction of the user, the current mode of operation of the display apparatus, and to control the visual indicator via the drive signal.

In an embodiment, the processor is implemented by way of hardware, software, firmware or a combination of these, suitable for controlling the operation of the display apparatus.

Throughout the present disclosure, the term “mode of operation” used herein relates to a manner in which the display apparatus is operated to provide a given level of immersion (namely, an immersion state) of the user, when the user views the visual scene. Therefore, the current mode of operation of the display apparatus relates to a present manner of operation of the display apparatus.

Throughout the present disclosure, the term “drive signal” used herein relates to an operative signal used to control operation of the visual indicator. Additionally, optionally, the drive signal is based at least partially upon at least one of: preference of the user, preference of the viewer present in the user's surroundings, nature of the user's surroundings.

As an example, the current mode of operation of the display apparatus may be the augmented reality mode. In such an instance, the processor may generate a drive signal S, based upon the current mode of operation of the display apparatus and the gaze direction of the user. For example, the drive signal S may control the visual indicator to emit orange-colored light to indicate that the user is gazing at a real-world object in the user's surroundings, whilst experiencing the augmented reality visual scene. Such emission of the orange-colored light may indicate a low level of immersion of the user within the augmented reality visual scene. Alternatively, the drive signal S may control the visual indicator to emit blue-colored light to indicate that the user is gazing at a virtual object, whilst experiencing the augmented reality visual scene. Such emission of the blue-colored light may indicate a high level of immersion of the user within the augmented reality visual scene.

Optionally, the processor is configured to provide the user with an option to choose from a plurality of modes of operation of the display apparatus and to employ the visual indicator to indicate the current mode of operation of the display apparatus to the viewer. Throughout the present disclosure, the term “plurality of modes of operations” used herein relates to different manners of operating the display apparatus to provide a plurality of levels of immersion (namely, a plurality of immersion states) of the user, when the user views the visual scene. Furthermore, optionally, the plurality of modes of operation comprises: the true reality mode, the augmented reality mode, the virtual reality mode.

In an embodiment, in the true reality mode, the visual scene is created in a manner that the projection of the real world image is projected onto the user's eyes whereas the projection of the rendered image is suppressed from being projected onto the user's eyes. In such a case, the level of immersion of the user is low since the user is able to perceive the real-world occurrences around him/her.

In another embodiment, in the augmented reality mode, the visual scene is created in a manner that both the projection of the real world and the projection of the rendered image are projected onto the user's eyes. In such a case, the level of immersion of the user is moderate since the user is able to partially perceive the real-world occurrences around him/her.

In yet another embodiment, in the virtual reality mode, the visual scene is created in a manner that the projection of the rendered image is projected onto the user's eyes whereas the projection of the real world image is suppressed from being projected onto the user's eyes. In such a case, the level of immersion of the user is high since the user is substantially unable to perceive the real-world occurrences around him/her.

Optionally, the virtual reality mode further comprises: (i) a regular virtual reality mode, (ii) an ultimate virtual reality mode. In the regular virtual reality mode, the user is unable to perceive visual real-world occurrences around him/her, whereas the user is able to perceive auditory real-world occurrences (namely, hear sounds) around him/her. In the ultimate virtual reality mode, the user is unable to perceive both the visual and the auditory real-world occurrences around him/her. It will be appreciated that the level of immersion of the user when the display apparatus operates in the regular virtual reality mode, may be lesser than the level of immersion of the user when the display apparatus operates in the ultimate virtual reality mode.

Furthermore, optionally, the processor may employ the visual indicator to indicate the current mode of operation of the display apparatus to the viewer by way of at least one of: color-based indication, image indication, textual indication. As an example, the processor may display text ‘Ultimate Virtual Reality Mode’ on the visual indicator via the drive signal, when the current mode of operation of the display apparatus is the ultimate virtual reality mode.

Optionally, the display apparatus has a touch-sensitive outer surface on at least one side of the display apparatus, and the processor is configured to detect when the user touches the touch-sensitive outer surface, and to switch between the plurality of modes of operations when the user touches the touch-sensitive outer surface. Throughout the present disclosure, the term “touch-sensitive outer surface” relates to equipment comprising touch (namely, tactile) sensors that detect the user's touch and transmit such detected touch to the processor.

As an example, the current mode of operation of the display apparatus may be the ultimate virtual reality mode. However, if the user wants to view the true reality mode, the user may then touch/press the touch-sensitive outer surface. Consequently, the processor of the display apparatus may switch between the current mode of operation (namely, the ultimate virtual reality mode) and the true reality mode.

As another example, the current mode of operation of the display apparatus may be the true reality mode. However, if the user wants to view the augmented reality mode, he/she may touch/press the touch-sensitive outer surface. Consequently, the processor of the display apparatus may switch between the true reality mode and the augmented reality mode.

Optionally, the touch-sensitive outer surface is employed by the user to control a number of virtual objects rendered in the visual scene, when the current mode of operation of the display apparatus is the virtual reality mode or the augmented reality mode. In such an instance, a duration of the user touching the touch-sensitive outer surface may be directly related to the number of virtual objects rendered in the visual scene.

Optionally, the visual indicator comprises at least one light-emitting element that is arranged on the outer side of the display apparatus, and wherein the processor is configured to control a color and/or intensity of light emitted by the at least one light-emitting element. Throughout the present disclosure, the term “outer side of the display apparatus” used herein relates to an exterior surface of the display apparatus that is visible to the viewer present in the user's surroundings. Throughout the present disclosure, the term “at least one light emitting element” used herein relates to at least one light source configured to emit light to provide the visual indication, to the viewer within user's surroundings, about user's level of immersion in the simulated environment. Optionally, in this regard, the at least one light emitting element is configured to emit light of visible wavelength. Notably, the drive signal is configured to control the color and/or the intensity of light emitted by the at least one light-emitting element. Furthermore, optionally, the at least one light emitting element emits light of different colors and/or intensities. In such an instance, the processor is configured to control the color and/or intensity of light emitted by the at least one light-emitting element in order to indicate different levels of immersion of the user.

As an example, a low amplitude drive signal may control the at least one light emitting element to emit light having low intensity, whereas a high amplitude drive signal may control the at least one light emitting element to emit light having high intensity. Optionally, the processor is further configured to control other properties of the light (for example, such as wavelength, optical path, and so forth) emitted by the at least one light emitting element.

Furthermore, optionally, the at least one light emitting element is implemented by way of at least one of: light emitting diodes, lamps and the like.

Optionally, the at least one light emitting element is configured to emit light of different colors. Alternatively, optionally, the at least one light emitting element is configured to emit light of a same color, whilst varying intensity of the same color.

In an example, the at least one light emitting element emits light of different colors to indicate different levels of immersion of the user in the simulated environment. For example, the at least one light emitting element may emit a green light to indicate the viewer that the user of the display apparatus is currently available for interaction, whereas the at least one light emitting element may emit a red light to indicate the viewer that the user of the display apparatus is completely immersed in the simulated environment, and is therefore unavailable for interaction.

In another example, different shades of a same color may be emitted by the at least one light emitting element to indicate different levels of immersion of the user in the simulated environment. For example, the at least one light emitting element may emit light of light blue color to indicate a low level of immersion of the user (for example, when the display apparatus operates in the true reality mode) whereas the at least one light emitting element may emit a light of red color to indicate a high level of immersion of the user (for example, when the display apparatus operates in the virtual reality mode).

Optionally, the processor is configured to control a number of illuminated at least one light-emitting element, to indicate different levels of immersion of the user in the simulated environment. As an example, the display apparatus may comprise ten light-emitting elements on the outer surface of the display apparatus, wherein the ten light emitting elements are operable to emit a same color of light. In such example, if the user of the display apparatus is currently available for interaction, it implies that the level of immersion of the user is low (for example, such that user is 10% immersed in the simulated environment), and consequently only one of the ten light-emitting elements may emit a white light. However, if the user of the display apparatus is currently unavailable for interaction, it implies that the level of immersion of the user is high (for example, such that user is 90% immersed in the simulated environment), and consequently, nine of the ten light-emitting elements may emit the white light.

Optionally, the visual indicator comprises a world-facing display that is arranged on the outer side of the display apparatus, and wherein the processor is configured to render, at the world-facing display, at least a portion of a viewport visible to the user, and to indicate on the rendered viewport the region of interest at which the user is gazing. Optionally, in this regard, the drive signal is configured to operate the visual indicator to indicate the region of interest at which the user is gazing. Throughout the present disclosure, the term “world-facing display” used herein relates to a screen that allows for rendering thereon, at least the portion of the viewport visible to the user. It will be appreciated that such a world-facing display allows for the viewer present in the user's surroundings to be aware of the visual scene that is presented to the user. In an example, wherein the visual scene depicts the user's surroundings having at least one virtual object overlaid hereon, such a world-facing display may indicate whether the user is gazing at the at least one virtual object or his/her surroundings. Furthermore, the indication of the region of interest on the rendered viewport, beneficially indicates the viewer about the level of immersion of the user.

Optionally, such an indication is provided by way of at least one of: changing brightness of the region of interest with respect to a remaining region of the rendered viewport, changing focus of the region of interest with respect to a remaining region of the rendered viewport, outlining the region of interest, directing a pointer at the region of interest. Optionally, in this regard, the pointer is selected from the group consisting of: an icon, an arrow, a text box.

As an example, a visual scene of an augmented reality simulated environment may be presented to the user. Such an augmented reality environment may comprise a beach environment whereat the user is positioned, having virtual objects such as virtual people overlaid thereon. In such an instance, a viewer present in the user's surroundings (namely, the beach) may view at least a portion of a viewport visible to the user, and also view the region of interest at which the user is gazing. In such an example, if the region of interest is sand of the beach, it indicates that the user is highly immersed in the real world even whilst viewing the augmented reality environment. Alternatively, if the region of interest is the virtual people, it indicates that the user is lightly immersed in the real world whilst viewing the augmented reality environment. Furthermore, in such an example, the indication may be provided by way of changing the focus of the region of interest with respect to a remaining region of the rendered viewport, in a manner that the region of interest is resolved to a greater degree of focus (namely, is clearer, or less blurry) as compared to the remaining region of the rendered viewport.

Furthermore, optionally, the world-facing display is configured to indicate the level of immersion of the user. In an embodiment, the world-facing display employs at least one of: numeric, alphabetical, alphanumeric characters, to indicate the level of immersion of the user. Optionally, the world-facing display is implemented by way of at least one of: Light-emitting diode (LED) display, Electroluminescent display (ELD), Plasma display panel (PDP), Liquid crystal display (LCD).

Optionally, the processor is configured to employ the visual indicator to indicate to the viewer whether or not the user is able to hear sounds emerging from the user's surroundings. Throughout the present disclosure, the term “sounds emerging from the user's surroundings” used herein relates to auditory real-world occurrences within the user's surroundings. In an example, the sounds emerging from the user's surroundings may comprise the viewer's voice. In another example, the sounds emerging from the user's surroundings may comprise sounds associated with objects within the user's surroundings, for example, such as ringing of a bell, sound of a fire alarm, sound of a mobile phone ringing, and so forth.

Optionally, the visual indicator implemented by way of the at least one light-emitting element emits a specific color of light to indicate whether the user is able to hear the sounds emerging from the user's surroundings. For example, if the user is unable to hear the sounds emerging from the user's surroundings, the at least one light-emitting element may emit a red light. On the other hand, if the user is able to hear the sounds emerging from the user's surroundings, the at least one light-emitting element may emit a green light.

Optionally, the visual indicator implemented by way of the world-facing display indicates whether or not the user is able to hear sounds emerging from the user's surroundings. For example, the world-facing display is operable to display a sign of ‘no audio’ in case the user is unable to hear the sounds emerging from his/her surroundings, and a sign of ‘audio enabled’ in case the user is able to hear the sounds emerging from his/her surroundings.

Optionally, the processor is configured to employ the visual indicator to provide a do-not-disturb indication to the viewer when the user is occupied with a predefined task. Throughout the present disclosure, the term “predefined task” used herein relates to an assignment (namely, an engagement) associated with the visual scene, that the user may partake whilst using the display apparatus. In such an instance, the viewer could be highly immersed within the visual scene, and may not desire any interruptions on account of occurrences within his/her surroundings.

Optionally, the predefined task is defined based upon the user's preferences. In an example, the predefined tasks may be attending a virtual meeting. In another example, the predefined tasks may be playing an ultimate virtual reality game. In yet another example, the predefined tasks may be meditating in a regular virtual reality environment.

More optionally, the display apparatus comprises a provision enabling the user to set a date and/or a time for executing the predefined task.

Furthermore, optionally, provision of the do-not-disturb indication may be based upon the user's preferences and/or system defined parameters.

It will be appreciated that such a do-not-disturb indication allows for providing the user with an unperturbed immersive experience of the visual scene. Whilst the do-not-disturb indication is provided, the viewer present in the user's surroundings would refrain from disturbing the user engaged in the predefined task.

Optionally, the do-not-disturb indication may be provided by the world-facing display by way of: colour-based indication, icon indication, image indication, textual indication. Furthermore, optionally, the do-not-disturb indication may be provided by the at least one light-emitting element by way of at least one of: a colour-based indication, a blinking indication. For example, the at least one light-emitting element may blink whilst the user is engaged in the predefined task, to provide the do not disturb indication to the viewer.

The present disclosure also relates to the method as described above. Various embodiments and variants disclosed above apply mutatis mutandis to the method.

### DETAILED DESCRIPTION OF THE DRAWINGS

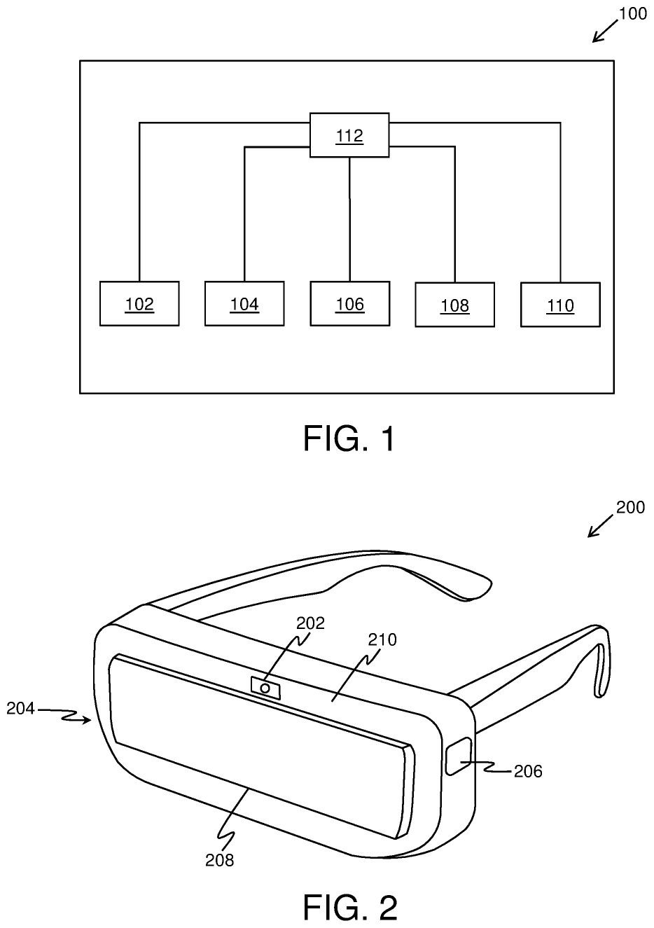

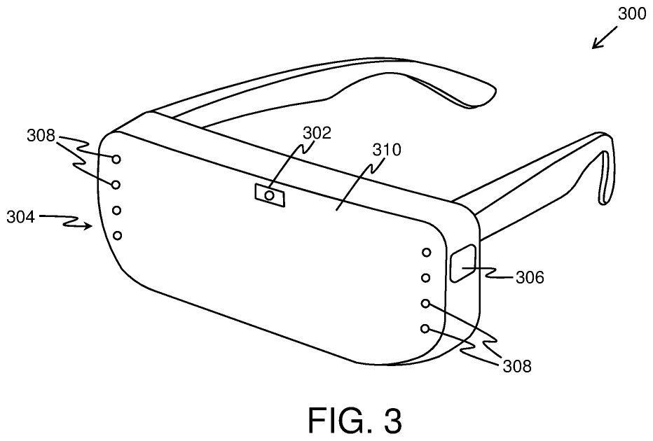

Referring to FIG. 1, illustrated is a block diagram of architecture of a display apparatus 100, in accordance with an embodiment of the present disclosure. As shown, the display apparatus 100 comprises at least one image renderer, depicted as an image renderer 102, for rendering an image; a see through arrangement 104 for projecting a real world image upon a user's eyes, when the display apparatus 100 is head-mounted by the user; at least one optical combiner, depicted as an optical combiner 106, for optically combining a projection of the rendered image with a projection of the real world image to create a visual scene; means for detecting a gaze direction 108 of the user; a visual indicator 110 for indicating a level of immersion of the user when the display apparatus 100 is in use, the visual indicator 110 being positioned on an outer side (shown in FIGS. 2 and 3) of the display apparatus 100, so as to be visible to a viewer (not shown) present in the user's surroundings; and a processor 112 coupled to the at least one image renderer 102, the see-through arrangement 104, the at least one optical combiner 106, the means for detecting the gaze direction 108, and the visual indicator 110. The processor 112 is configured to generate a drive signal for the visual indicator 100, based upon at least one of: the gaze direction of the user, a current mode of operation of the display apparatus 100, and to control the visual indicator 110 via the drive signal.

Referring to FIGS. 2 and 3, illustrated are perspective views of the display apparatus 100 (as shown in FIG. 1), in accordance with different embodiments of the present disclosure. It may be understood by a person skilled in the art that the FIGS. 2 and 3 include simplified exemplary arrangements of the display apparatus 100 for sake of clarity, which should not unduly limit the scope of the claims herein. The person skilled in the art will recognize many variations, alternatives, and modifications of embodiments of the present disclosure.

Referring to FIG. 2, illustrated is a perspective view of the display apparatus 200 (for example, such as the display apparatus 100 of FIG. 1) in accordance with an embodiment of the present disclosure. The display apparatus 200 comprises at least one image renderer (for example, such as the image renderer 102 of FIG. 1) for rendering an image; a see through arrangement 202 for projecting a real world image upon a user's eyes, when the display apparatus 200 is head-mounted by the user; at least one optical combiner (for example, such as the optical combiner 106 of FIG. 1) for optically combining a projection of the rendered image with a projection of the real world image to create a visual scene; means for detecting a gaze direction (for example, such as the means for detecting a gaze direction 108 of FIG. 1) of the user, a visual indicator 204 for indicating a level of immersion of the user when the display apparatus 200 is in use, the visual indicator 204 being positioned on an outer side of the display apparatus 200, so as to be visible to a viewer (not shown) present in the user's surroundings; and a processor (for example, such as the processor 112 of FIG. 1) coupled to the at least one image renderer, the see-through arrangement 202, the at least one optical combiner, the means for detecting the gaze direction, and the visual indicator 204. The processor of the display apparatus 200 is configured to generate a drive signal for the visual indicator 204, based upon at least one of: the gaze direction of the user, a current mode of operation of the display apparatus 200, and to control the visual indicator 204 via the drive signal.

Optionally, as shown in FIG. 2, the display apparatus 200 has a touch-sensitive outer surface 206 on at least one side of the display apparatus 200. Furthermore, optionally, the processor is configured to detect when the user touches the touch-sensitive outer surface 206, and to switch between a plurality of modes of operation of the display apparatus 200 when the user touches the touch-sensitive outer surface 206. Moreover, optionally, as shown in FIG. 2, the visual indicator 204 comprises a world-facing display 208 that is arranged on an outer side 210 of the display apparatus 200. The processor is optionally configured to render, at the world-facing display 208, at least a portion of a viewport visible to the user, and to indicate on the rendered viewport a region of interest at which the user is gazing.

Referring to FIG. 3, illustrated is a perspective view of the display apparatus 300 (for example, such as the display apparatus 100 of FIG. 1) in accordance with another embodiment of the present disclosure. As shown, the display apparatus 300 comprises at least one image renderer (for example, such as the image renderer 102 of FIG. 1) for rendering an image; a see through arrangement 302 for projecting a real world image upon a user's eyes, when the display apparatus 300 is head-mounted by the user; at least one optical combiner (for example, such as the optical combiner 106 of FIG. 1) for optically combining a projection of the rendered image with a projection of the real world image to create a visual scene; means for detecting a gaze direction (for example, such as the means for detecting a gaze direction 108 of FIG. 1) of the user, a visual indicator 304 for indicating a level of immersion of the user when the display apparatus 300 is in use, the visual indicator 304 being positioned on an outer side of the display apparatus 300, so as to be visible to a viewer (not shown) present in the user's surroundings; and a processor (for example, such as the processor 112 of FIG. 1) coupled to the at least one image renderer, the see-through arrangement 302, the at least one optical combiner, the means for detecting the gaze direction, and the visual indicator 304. The processor is configured to generate a drive signal for the visual indicator 304, based upon at least one of: the gaze direction of the user, a current mode of operation of the display apparatus 300, and to control the visual indicator 304 via the drive signal.

Optionally, as shown in FIG. 3, the display apparatus 300 has a touch-sensitive outer surface 306 on at least one side of the display apparatus 300. Furthermore, optionally, the processor is configured to detect when the user touches the touch-sensitive outer surface 306, and to switch between a plurality of modes of operation when the user touches the touch-sensitive outer surface 306. Moreover, optionally, as shown in FIG. 3, the visual indicator 304 comprises at least one light-emitting element, depicted as light-emitting elements 308, that is arranged on the outer side of the display apparatus 300, and wherein the processor is configured to control a color and/or intensity of light emitted by the at least one light-emitting element 308.

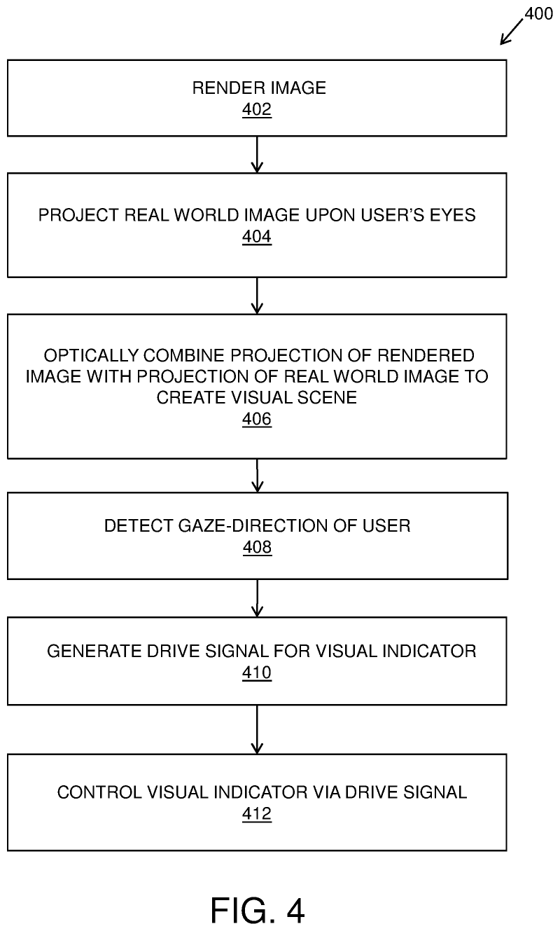

Referring to FIG. 4, illustrated are steps of a method 400 for indicating a level of immersion of a user of a display apparatus (for example, such as the display apparatus 100 of FIG. 1), in accordance with an embodiment of the present disclosure. At step 402, an image is rendered via the at least one image renderer. At step 404, a real world image is projected upon the user's eyes, via a see-through arrangement, when the display apparatus is head-mounted by the user. At step 406, a projection of the rendered image is optically combined with a projection of the real world image to create a visual scene via at least one optical combiner. At step 408, the gaze-direction of the user is detected via means for detecting the gaze direction. At step 410, a drive signal for a visual indicator is generated based upon at least one of: the gaze direction of the user, a current mode of operation of the display apparatus. Furthermore, at step 412, the visual indicator is controlled, via the drive signal, to indicate the level of immersion of the user when the display apparatus is in use.

The steps 402 to 412 are only illustrative and other alternatives can also be provided where one or more steps are added, one or more steps are removed, or one or more steps are provided in a different sequence without departing from the scope of the claims herein. For example, the method 400 may further comprise providing the user with an option to choose from a plurality of modes of operation of the display apparatus and employing the visual indicator to indicate the current mode of operation of the display apparatus to the viewer. Optionally, the display apparatus associated with the method 400 further comprises a touch-sensitive outer surface on at least one side of the display apparatus and the method 400 further comprises detecting when the user touches the touch-sensitive outer surface and switching between the plurality of modes of operation when the user touches the touch-sensitive outer surface. Optionally, the method 400 comprises controlling the see-through arrangement and/or the at least one optical combiner to provide different transparency levels for the real world image when creating the visual scene and employing the visual indicator to indicate to the viewer whether or not the user is able to see the viewer in the real world image. Optionally, the method 400 also comprises employing the visual indicator to indicate to the viewer whether or not the user is able to hear sounds emerging from the user's surroundings. Moreover, optionally, the method 400 comprises employing the visual indicator to provide a do-not-disturb indication to the viewer when the user is occupied with a predefined task. Optionally the display apparatus associated with the method 400 further comprises at least one light-emitting element that is arranged on the outer side of the display apparatus, and the method 400 further comprises controlling a color and/or intensity of light emitted by the at least one light-emitting element. Additionally, optionally, the display apparatus associated with the method 400 further comprises a world-facing display that is arranged on the outer side of the display apparatus, and the method 400 further comprises rendering, at the world-facing display, at least a portion of a viewport visible to the user and indicating on the rendered viewport a region of interest at which the user is gazing. Furthermore, optionally, the method 400 comprises determining the region of interest based upon the detected gaze direction of the user.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A display apparatus comprising:
at least one image renderer for rendering an image;
a see-through arrangement for projecting a real world image upon a user's eyes, when the display apparatus is head-mounted by the user;
at least one optical combiner for optically combining a projection of the rendered image with a projection of the real world image to create a visual scene;
means for detecting a gaze-direction of the user;
a visual indicator for indicating a level of immersion of the user when the display apparatus is in use, the visual indicator being positioned on an outer side of the display apparatus, so as to be visible to a viewer present in the user's surroundings; and
a processor coupled to the at least one image renderer, the see-through arrangement, the at least one optical combiner, the means for detecting the gaze direction, and the visual indicator, wherein the processor is configured to generate a drive signal for the visual indicator, based upon at least one of: the gaze direction of the user, a current mode of operation of the display apparatus, and to control the visual indicator via the drive signal.

2. The display apparatus of claim 1, wherein the processor is configured to provide the user with an option to choose from a plurality of modes of operation of the display apparatus, and to employ the visual indicator to indicate the current mode of operation of the display apparatus to the viewer.

3. The display apparatus of claim 2, wherein the display apparatus has a touch-sensitive outer surface on at least one side of the display apparatus, and the processor is configured to detect when the user touches the touch-sensitive outer surface, and to switch between the plurality of modes of operation when the user touches the touch-sensitive outer surface.

4. The display apparatus of claim 1, wherein the processor is configured to control the see-through arrangement and/or the at least one optical combiner to provide different transparency levels for the real world image when creating the visual scene, and to employ the visual indicator to indicate to the viewer whether or not the user is able to see the viewer in the real world image.

5. The display apparatus of claim 1, wherein the processor is configured to employ the visual indicator to indicate to the viewer whether or not the user is able to hear sounds emerging from the user's surroundings.

6. The display apparatus of claim 1, wherein the processor is configured to employ the visual indicator to provide a do-not-disturb indication to the viewer when the user is occupied with a predefined task.

7. The display apparatus of claim 1, wherein the visual indicator comprises at least one light-emitting element that is arranged on the outer side of the display apparatus, and wherein the processor is configured to control a color and/or intensity of light emitted by the at least one light-emitting element.

8. The display apparatus of claim 1, wherein the visual indicator comprises a world-facing display that is arranged on the outer side of the display apparatus, and wherein the processor is configured to render, at the world-facing display, at least a portion of a viewport visible to the user, and to indicate on the rendered viewport a region of interest at which the user is gazing.

9. The display apparatus of claim 8, wherein the processor is configured to determine the region of interest based upon the detected gaze direction of the user.

10. A method of indicating a level of immersion of a user of a display apparatus, the display apparatus comprising at least one image renderer, a see-through arrangement, at least one optical combiner, means for detecting a gaze-direction of the user, and a visual indicator, the visual indicator being positioned on an outer side of the display apparatus, so as to be visible to a viewer present in the user's surroundings, the method comprising:
rendering an image via the at least one image renderer;
projecting a real world image upon the user's eyes, via the see-through arrangement, when the display apparatus is head-mounted by the user;
optically combining, via the at least one optical combiner, a projection of the rendered image with a projection of the real world image to create a visual scene;
detecting the gaze-direction of the user, via the means for detecting the gaze direction;
generating a drive signal for the visual indicator, based upon at least one of: the gaze direction of the user, a current mode of operation of the display apparatus; and
controlling the visual indicator, via the drive signal, to indicate the level of immersion of the user when the display apparatus is in use.

11. The method of claim 10, further comprising:
providing the user with an option to choose from a plurality of modes of operation of the display apparatus; and
employing the visual indicator to indicate the current mode of operation of the display apparatus to the viewer.

12. The method of claim 11, wherein the display apparatus has a touch-sensitive outer surface on at least one side of the display apparatus, and the method further comprises:
detecting when the user touches the touch-sensitive outer surface; and
switching between the plurality of modes of operation when the user touches the touch-sensitive outer surface.

13. The method of claim 10, further comprising:
controlling the see-through arrangement and/or the at least one optical combiner to provide different transparency levels for the real world image when creating the visual scene; and
employing the visual indicator to indicate to the viewer whether or not the user is able to see the viewer in the real world image.

14. The method of claim 10, further comprising employing the visual indicator to indicate to the viewer whether or not the user is able to hear sounds emerging from the user's surroundings.

15. The method of claim 10, further comprising employing the visual indicator to provide a do-not-disturb indication to the viewer when the user is occupied with a predefined task.

16. The method of claim 10, wherein the visual indicator comprises at least one light-emitting element that is arranged on the outer side of the display apparatus, and the method further comprises controlling a color and/or intensity of light emitted by the at least one light-emitting element.

17. The method of claim 10, wherein the visual indicator comprises a world-facing display that is arranged on the outer side of the display apparatus, and the method further comprises:
rendering, at the world-facing display, at least a portion of a viewport visible to the user; and
indicating on the rendered viewport a region of interest at which the user is gazing.

18. The method of claim 17, further comprising determining the region of interest based upon the detected gaze direction of the user.
